(19) United States
(12) Patent Application Publication
(10) Pub. No.: US 2026/0242101 A1
(43) Pub. Date: Aug. 20, 2026

(54) CLOSURE

(71) Applicant: BB Coffee Company GmbH, Unterhaching (DE)

(72) Inventors: Bernd BRAUNE, Unterhaching (DE); Franz Xaver HOFSTETTER, Bad Endorf (DE)

(21) Appl. No.: 19/541,731

(22) Filed: Feb. 17, 2026

(30) Foreign Application Priority Data
Feb. 17, 2025 (EP) 25158336.5

(51) Int. Cl. B65D 43/02

(52) U.S. Cl. CPC B65D 43/0229; B65D 2543/00092; B65D 2543/00277; B65D 2543/00296

(57) ABSTRACT

A closure having a cylindrical receiving part with a cylinder axis and a cylindrical insert part coaxial with the receiving part. The insert part can be inserted into the receiving part and rotated to a closing position. During rotation, at least two locking projections of the insert part rest in each case against a locking projection of the receiving part. Further rotation generates a radial force acting on the locking projections which presses the radial projections radially inwards and elliptically deforms the end of the insert part facing the receiving part. The locking projections of the receiving part are passed over by the locking projections of the insert part to achieve a stable closing position. With the application of force, the insert part can be rotated in an opposite direction to an open position.

This application claims priority to European patent application number 25158336.5 filed 17 Feb. 2025. The disclosure of the aforementioned application is hereby incorporated herein by reference in its entirety.

### FIELD OF THE INVENTION

The present invention relates to a closure, in particular to a detachable mechanical connection between two cylindrical parts which can be connected by inserting them into each other and rotating them, and can be disconnected again, according to the independent claim(s).

### BACKGROUND OF THE INVENTION

Such fasteners are known from the prior art; examples include so-called bayonet fasteners.

### SUMMARY OF THE INVENTION

The present invention is based on the object of specifying a closure of the type mentioned at the outset, which can be produced cost-effectively, is easy to handle, and can be transferred to the open position in a non-destructive manner.

This object is achieved by the features of the independent claim(s). Further embodiments and advantages are apparent from the subclaims.

Accordingly, a closure is proposed comprising a cylindrical receiving part with a cylinder axis and a cylindrical insert part coaxial with the receiving part, wherein the insert part can be inserted into the receiving part and can be transferred therein into a closure position by rotation in a direction of rotation about the cylinder axis.

Before reaching the closing position, at least two diametrically opposite locking projections of the insert part, which are ramp-shaped in the circumferential direction, rest in each case against a locking projection of the receiving part, which is ramp-shaped in the circumferential direction, as viewed in the circumferential direction, wherein during the further rotation process to reach the closing position, a radial, inwardly directed force acting on the locking projections of the insert part can be generated by the locking projections of the receiving part.

According to the invention, the insert part is designed in such a manner that the force acting on the locking projections pushes the latching projections radially inwards in such a manner that as a result of the thereby generated elliptical deformation of the end of the insert part facing the receiving part, the locking projections of the receiving part are passed over by the locking projections of the insert part, whereby a stable closing position can be achieved, which can be transferred to an open position by rotation of the insert part in an opposite direction with the application of force. In the closing position, no radially inwardly directed force acts on the latching projections of the insert part since the locking projections of the insert part and the receiving part rest against each other in the circumferential direction SO that the latter has the original cylindrical shape.

The insert part is thus designed in such a manner that it deforms substantially elliptically by a force acting radially inwards on the latching projections, with the minor axis of the ellipse connecting the two locking projections to each other.

The receiving part and the insert part can be made of metal and/or plastics. According to one embodiment, the locking projections of the receiving part are designed to have a steeper ramp shape on the side facing the locking projections of the insert part in the closing position, when viewed in the circumferential direction, than on the side facing away from the locking projections of the insert part in the closing position, when viewed in the circumferential direction. This advantageously ensures that a higher force is required to open the closure than to transfer the closure to the closing position.

The receiving part can be designed, for example, as a mill body, and the insert part can be designed as a container for the ground material of a hand-operated household mill, in particular a hand-operated coffee mill or a hand-operated mill for salt, pepper, grain, rice or spices. Alternatively, the receiving part can be integrated or integrally integrated, for example, into the mill body, and the insert part can be integrated or integrally integrated into the container for the material to be ground of a hand-operated household mill, in particular a hand-operated coffee mill or a hand-operated mill for salt, pepper, grain, rice or spices. Furthermore, the insert part can be a container, and the receiving part can be a lid of the container.

According to a particularly advantageous embodiment of the invention, the receiving part has two diametrically opposite, partially ring-shaped projections of defined pitch which extend radially inwards and at the end thereof, which has the smaller distance from the end of the receiving part facing the insert part in the state connected to the insert part, a locking projection designed to be ramp-shaped in the circumferential direction is provided in each case on the side of the projections facing away from the insert part.

Furthermore, the lateral surface of the insert part, at its end facing the receiving part in the state connected to the receiving part, has two diametrically opposite and radially elastically deformable regions with a smaller thickness than the remaining lateral surface, and two diametrically opposite locking projections which are designed to ramp-shaped in the circumferential direction and which are provided substantially offset by 90° in the circumferential direction from the center of the elastically deformable regions.

By providing the elastically deformable regions of smaller thickness, the elliptical deformation of the insert part is achieved with a force acting radially inwards on the locking projections, and the return of the insert part to the original cylindrical shape after completion of the rotary movement for transferring the closure to the closing position is also achieved.

Furthermore, the elastically deformable regions are each followed by a further region of smaller thickness, which extends as a partially ring-shaped, threaded notch with a defined pitch to below the locking projections in order to create a screw connection in interaction with the radially inwardly extending projections of the receiving part.

The insert part can be inserted into the receiving part and transferred to a closing position by rotating it in a direction of rotation about the cylinder axis, wherein, before reaching the closing position, the locking projections of the insert part rest in each case against a locking projection of the receiving part, as viewed in the circumferential direction.

During the further rotation process, the sliding of the locking projections of the insert part on the locking projections of the receiving part generates a radial force on the locking projections of the insert part, by means of which the elastically deformable regions of the insert part are pressed radially outwards such that as a result the thereby generated elliptical deformation of the end of the insert part facing the receiving part, locking projections of the receiving part are passed over by the locking projections of the insert part, whereby a stable closing position can be achieved which can be transferred to an open position by rotating the insert part in the opposite direction with the application of force.

It can be provided here that, in particular in the case where the receiving part is designed as a mill body and the insert part is designed as a container for the ground material of a hand-operated household mill or are integrated in each case in these components, a pocket for receiving ground material is provided at the end of the partially ring-shaped, threaded notches of the insert part. As a result, the advantage is achieved that ground material, which can impair the functionality of the closure, is collected in the pockets during the rotary movement.

### BRIEF DESCRIPTION OF THE DRAWINGS

The invention is explained in more detail below by way of example with reference to the accompanying figures, which show advantageous embodiments. The same reference numerals denote the same components. In the figures:

FIG. 1 shows a schematic perspective view of an insert part according to a first embodiment of the invention;

FIG. 2 shows a further perspective view of the insert part according to FIG. 1;

FIG. 3 shows a schematic perspective view of an insert part which differs from the insert part according to FIGS. 1 and 2 in that a pocket is provided for the ground material;

FIG. 4 shows a schematic perspective view of a receiving part according to one embodiment of the invention; and

FIG. 5 shows a schematic perspective view of an insert part according to FIGS. 1, 2, and 3 to illustrate the elliptical deformation during the rotation process.

### DETAILED DESCRIPTION OF THE PREFERRED EMBODIMENTS

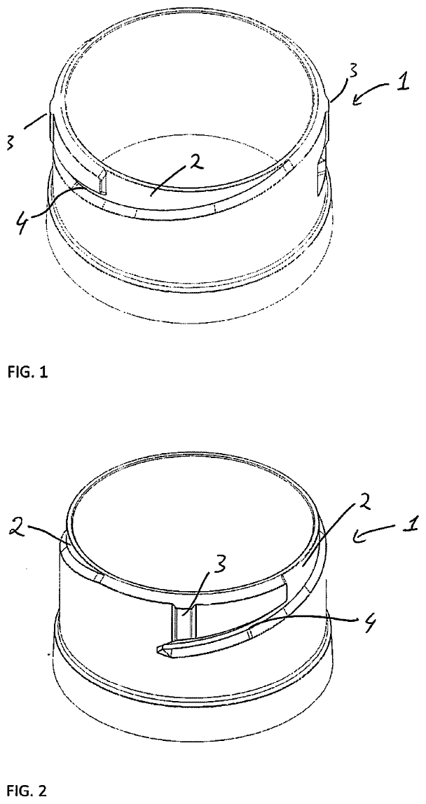

FIG. 1 shows an insert part 1 designed according to the invention. As can be seen in FIG. 1, the lateral surface of the insert part 1, in its state connected to the receiving part, has two diametrically opposed and radially elastically deformable regions 2 with a smaller thickness than the remaining lateral surface and two diametrically opposed locking projections 3 which are ramp-shaped in the circumferential direction and which are arranged substantially offset by 90° in the circumferential direction from the center of the elastically deformable regions 2.

As can be seen in particular from FIG. 2, the elastically deformable regions 2 are each followed by a further region of smaller thickness, which extends as a partially ring-shaped, threaded notch 4 with a defined pitch to below the locking projections 3.

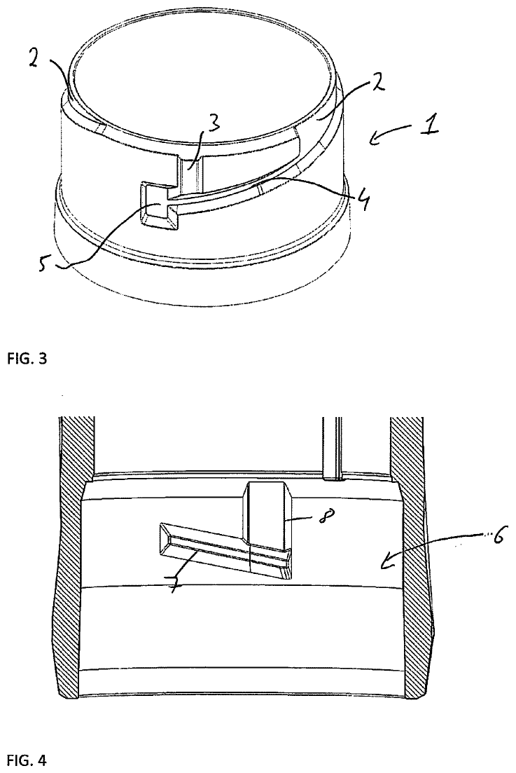

The embodiment of the insert part according to FIG. 3 corresponds to the embodiment according to FIGS. 1 and 2, with the difference that a pocket 5 is provided at the end of each of the partially ring-shaped, threaded notches 4 of the insert part. This is particularly advantageous if the receiving part is designed as a mill body and the insert part is designed as a container for the ground material of a hand-operated household mill or are integrated in each case in these components since as a result of this, the ground material, which can impair the functionality of the closure, is collected in the pockets 5 during the rotary movement.

FIG. 4 shows a receiving part 6 corresponding to the insert part according to FIGS. 1, 2, and 3. Here, the receiving part 6 has two diametrically opposed, partially ring-shaped projections 7 of defined pitch which extend radially inwards, at the end thereof, which has the smaller distance from the end of the receiving part 6 facing the insert part in the state connected to the insert part, a locking projection 8 designed to be ramp-shaped in the circumferential direction is provided on the side of the projections 7 facing away from the insert part. In the example shown, the illustrated receiving part 6 is integrated into the mill body of a hand-operated household mill, e.g., a coffee mill.

According to the invention, the notches 4 shown in FIGS. 1, 2, and 3, in interaction with the radially inwardly extending projections 7 of the receiving part 6 shown in FIG. 4, create a screw connection in the closing position.

According to the invention, the insert part 1 can be inserted into the receiving part 6 and can be transferred to a closing position by rotation in a direction of rotation about the common cylinder axis, wherein, before reaching the closing position, the locking projections 3 of the insert part 1 rest in each case against a locking projection 8 of the receiving part 6, as viewed in the circumferential direction, wherein a radial force acting on the locking projections 3 of the insert part 1 is generated during the further rotation process.

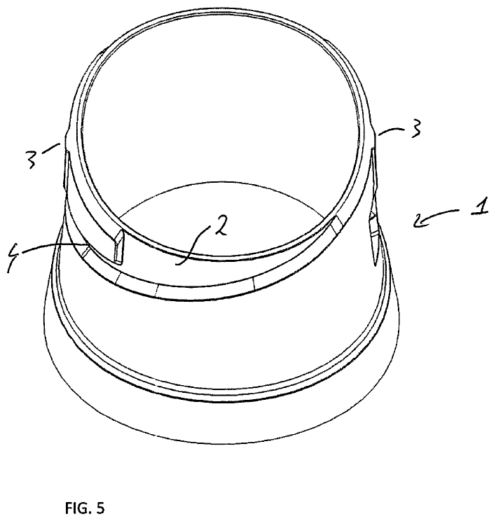

As a result, the elastically deformable regions 2 of the insert part 1 are be pressed outwards in the radial direction in such a manner that as a result of the thereby generated elliptical deformation of the end of the insert part 1 facing the receiving part 6, the locking projections 8 of the receiving part 6 are passed over by the locking projections 3 of the insert part 1, resulting in a stable closing position which can be transferred to an open position by rotation of the insert part in an opposite direction with the application of force. The elliptical deformation of the insert part 1 is illustrated in FIG. 5.

With the design concept according to the invention, a closure is created that can be produced cost-efficiently, is easy to handle, and can be transferred to the open position in a non-destructive manner; advantageously, no additional components, such as spring tabs, are required since this functionality is integrated into the insert part.

1. A closure, comprising a cylindrical receiving part (6) with a cylinder axis and a cylindrical insert part (1) coaxial with the receiving part (6), wherein the insert part (1) can be inserted into the receiving part (6) and can be transferred therein to a closing position by rotation in a direction of rotation about the cylinder axis, wherein, before the closing position is reached, at least two diametrically opposed locking projections (3) of the insert part, which are designed to be ramp-shaped in the circumferential direction, rest in each case against a locking projection (8) of the receiving part (6), which is designed to be ramp-shaped in the circumferential direction, as viewed in the circumferential direction, wherein during the further rotation process, a radial force acting on the locking projections (3) of the insert part (1) can be generated, wherein the insert part (1) is designed in such a manner that due to the force acting on the locking projections (3), the locking projections (3) are pressed radially inwards such that as a result of the thereby generated elliptical deformation of the end of the insert part (1) facing the receiving part (6), the locking projections (8) of the receiving part (6) are passed over by the locking projections (3) of the insert part, whereby a stable closing position can be achieved which can be transferred to an open position by rotating the insert part (1) in an opposite direction with the application of force.

2. The closure according to claim 1, wherein the locking projections (8) of the receiving part (6) are designed to have a steeper ramp shape on a side facing the locking projections (3) of the insert part (1) in the closing position, as viewed in the circumferential direction, than on a side facing away from the latching projections (3) of the insert part (1) in the closing position, as viewed in the circumferential direction.

3. The closure according to claim 1, wherein the receiving part (6) and the insert part (1) are made of metal and/or plastics.

4. The closure according to claim 1, wherein the receiving part (6) has two diametrically opposed projections (7) which extend radially inwards with a defined pitch and at the end thereof, which has the smaller distance to the end of the receiving part (6) facing the insert part (1) in the state connected to the insert part (1), a locking projection (8) designed to be ramp-shaped in the circumferential direction is provided on the side of the projections (7) facing away from the insert part (1),
wherein the lateral surface of the insert part (1), at its end facing the receiving part (6) in the state connected to the receiving part (6), has two diametrically opposite and radially elastically deformable regions (2) with a smaller thickness than the remaining lateral surface, and two diametrically opposite locking projections (3) designed to be ramp-shaped in the circumferential direction which are provided substantially offset by 90° in the circumferential direction from the center of the elastically deformable regions (2),
wherein the elastically deformable regions (2) are each followed by a further region of smaller thickness which extends as a partially ring-shaped, threaded notch (4) with a defined pitch extending to below the locking projections (3) in order to create a screw connection in interaction with the radially inwardly extending projections (7) of the receiving part (6),
wherein the insert part (1) can be inserted into the receiving part (6) and can be transferred therein to a closing position by rotation in a direction of rotation about the cylinder axis, wherein, before the closing position is reached, the locking projections (3) of the insert part rest in each case against a locking projection (8) of the receiving part, as viewed in the circumferential direction, wherein during the further rotation process, a radial force acting on the locking projections (3) of the insert part (1) is generated, due to which the elastically deformable regions (2) of the insert part (1) are pressed radially outwards in such a manner that as a result of the thereby generated elliptical deformation of the end of the insert part (1) facing the receiving part (6), the locking projections (8) of the receiving part (3) are passed over by the locking projections (3) of the insert part (1), whereby a stable closing position can be achieved, which can be transferred to an open position by rotating the insert part (1) in an opposite direction with the application of force.

5. The closure according to claim 4, wherein a pocket (5) is provided at the end of the partially ring-shaped, threaded notches (4) of the insert part (1).

6. The closure according to claims 1, wherein the receiving part (6) is a mill body and in that the insert part (1) is a container for the ground material of a hand-operated household mill, in particular a hand-operated coffee mill or a hand-operated mill for salt, pepper, grain, or spices, or in that the receiving part (6) is integrated or integrally into the mill body and the insert part (1) is integrated or integrally integrated into the container for the ground material of a hand-operated household mill, in particular a hand-operated coffee mill or a hand-operated mill for salt, pepper, grain or spices, or in that the insert part is a container and the receiving part is a lid for the container.
